(19) United States
(12) Patent Application Publication
(10) Pub. No.: US 2017/0004190 A1
(43) Pub. Date: Jan. 5, 2017

(54) SYSTEM AND METHOD FOR DATA VISUALIZATION

(71) Applicant: Umm Al-Qura University, Makkah (SA)

(72) Inventors: Mohamed MOKBEL, New Brighton, MN (US); Sohaib GHANI, Makkah (SA); Thanaa Ghanem, New Brighton, MN (US); Mashaal Musleh, Makkah (SA); Amr MAGDY, Makkah (SA)

(73) Assignee: Umm Al-Qura University, Makkah (SA)

(21) Appl. No.: 14/788,187

(22) Filed: Jun. 30, 2015

(51) Int. Cl. G06F 17/30; H04L 12/58

(52) U.S. Cl. CPC G06F 17/30572; G06F 17/3033; G06F 17/30601; H04L 51/08

(57) ABSTRACT

Aspects of the disclosure provide a system for visualizing microblog data. The system can include circuitry that is configured to receive a request for visual report from a user device, extract the selected microblog data from a database based on the request for visual report, create a pyramid data structure having a plurality of cells at different levels for data visualization based on microblog data within spatial and temporal ranges selected by a user, and create a visual report including a plurality of visual report interfaces based on the data structure.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Popularity of online social media services leads to explosive growth of microblog data. For example, every day, hundreds of millions of Twitter users post hundreds of millions of tweets, and more than one billion Facebook users post several billion comments. The microblog data can include various types of information such as text, location information, and user information. That information enables meaningful analysis tasks that can deduce fruitful conclusions for various purposes.

### SUMMARY

Aspects of the disclosure provide a system for visualizing microblog data. The system can include circuitry that is configured to receive a request for visual report from a user device, extract the selected microblog data from a database based on the request for visual report, create a pyramid data structure having a plurality of cells at different levels for data visualization based on microblog data within spatial and temporal ranges selected by a user, and create a visual report including a plurality of visual report interfaces based on the data structure.

In an embodiment, the request for visual report from a user device includes spatial and temporal ranges of selected microblog data and a categorical attribute to be analyzed. In an example, the categorical attribute to be analyzed is a language attribute, and the visual report shows counts and percentages of each language in each sub-region of a region corresponding to the spatial range of the selected microblog data and is used for language attribute analysis. In another embodiment, the categorical attribute to be analyzed is a source attribute, and the visual report shows counts and percentages of each operating system in each sub-region of a region corresponding to the spatial range of the selected microblog data and is used for source attribute analysis.

In an embodiment, the circuitry can be configured to compute counts of attribute categories of microblog data in each cell and store the counts of attribute categories in a hash table to create the pyramid data structure. The counts of attribute categories can be based on distinct users or distinct microblogs.

In an embodiment, the visual report interfaces can be based on a map having a plurality of zoom levels, and each zoom level corresponds to a level in the pyramid data structure. In addition, counts of attribute categories in a cell in the pyramid data structure can be displayed using a chart overlaid with a region in the map, and the region corresponds to the cell in the pyramid data structure. In an example, the visual report interfaces can include functions for a user to select the attribute categories to be displayed and choose to display the visual report interface based on distinct users or distinct microblogs.

In an embodiment, circuitry is further configured to generate a data selection interface for a user to select spatial and temporal ranges of microblog data and categorical attribute to be analyzed for the visual report.

In an embodiment, the circuitry is further configured to send an email to the user device, and the email can include a hyperlink to the visual interfaces generated at the visual interface generator.

Aspects of the disclosure provide a method for visualizing microblog data. The method is implemented by a system having circuitry, and can include receiving a request for visual report from a user device, extracting the selected microblog data from a database based on the request for visual report, creating a pyramid data structure having a plurality of cells at different levels for data visualization based on microblog data within spatial and temporal ranges selected by a user, and creating a visual report including a plurality of visual report interfaces based on the data structure.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary system for microblog data management according to an embodiment of the disclosure.

FIG. 2 shows an exemplary system for data visualization according to an embodiment of the disclosure;

FIGS. 3A-3C show exemplary interfaces generated by the system according to an embodiment of the disclosure;

FIG. 4 shows a flow chart of a process for data visualization according to an embodiment of the disclosure;

FIG. 5 shows an exemplary computing environment for implementing various aspects of the disclosure according to an embodiment of the disclosure;

FIG. 6 shows an exemplary data processing system, according to certain embodiments, for implementing various aspects of the disclosure; and

FIG. 7 shows an exemplary implementation of central processing unit according to an embodiment of the disclosure.

### DETAILED DESCRIPTION OF EMBODIMENTS

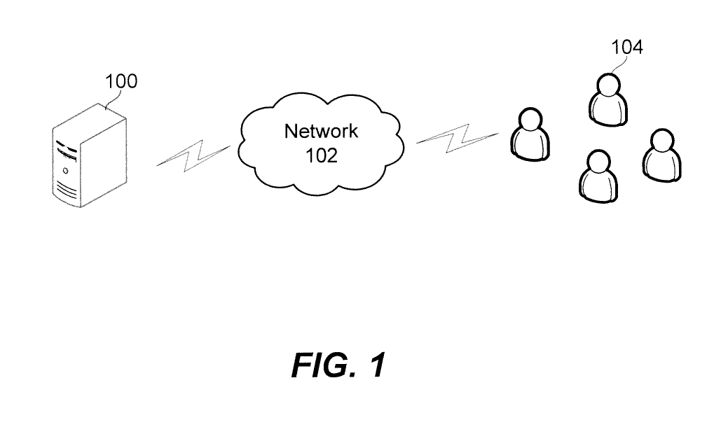

FIG. 1 shows an exemplary system for microblog data management according to an embodiment of the disclosure. As shown, a user 104 sends data to a server 100 via a network 102. The data may represent microblog data generated from social media services such as tweets, Facebook comments, and Foursquare check-ins. The user 104 may represent a plurality of users. The user 104 may generate the microblog data using a mobile device. The mobile device may be further equipped with a location detector in order to generate geotagged microblog data. For example, Global Positioning System (GPS) circuitry may be included in the mobile device as would be understood by one of ordinary skill in the art. In one embodiment, the mobile device location may be determined via a cellular tower with which communication has been established using current technologies such as Global System for Mobile (GSM) localization, triangulation, Bluetooth, hotspots, WiFi detection, or other methods as would be understood to one of ordinary skill in the art. In one embodiment, the mobile device location is determined by the network 102. In particular, the network 102 may detect a location of the mobile device as a network address on the network 102. The mobile device location corresponds to the user location. Once the mobile device location is determined by any of the techniques described above or other methods as known in the art, the user location is likely known. The user location is then associated with the microblog data sent by the user 104. The user 104 may also indicate the location using the mobile device. The server 100 manages the microblog data. Further, the user 104 may send one or more query to the server 100 via the network 102. The server 100 may process the query and send the answer to the mobile device of the user 104 via the network 102. The mobile device may be a smartphone, a computer, a tablet or the like.

The network 102 can be any network that allows the user 104 and the server to communicate with each other, such as a wide area network, local area network, or the internet. The server 100 may include a CPU and a memory. The server 100 may represent one or more servers connected via the network 102.

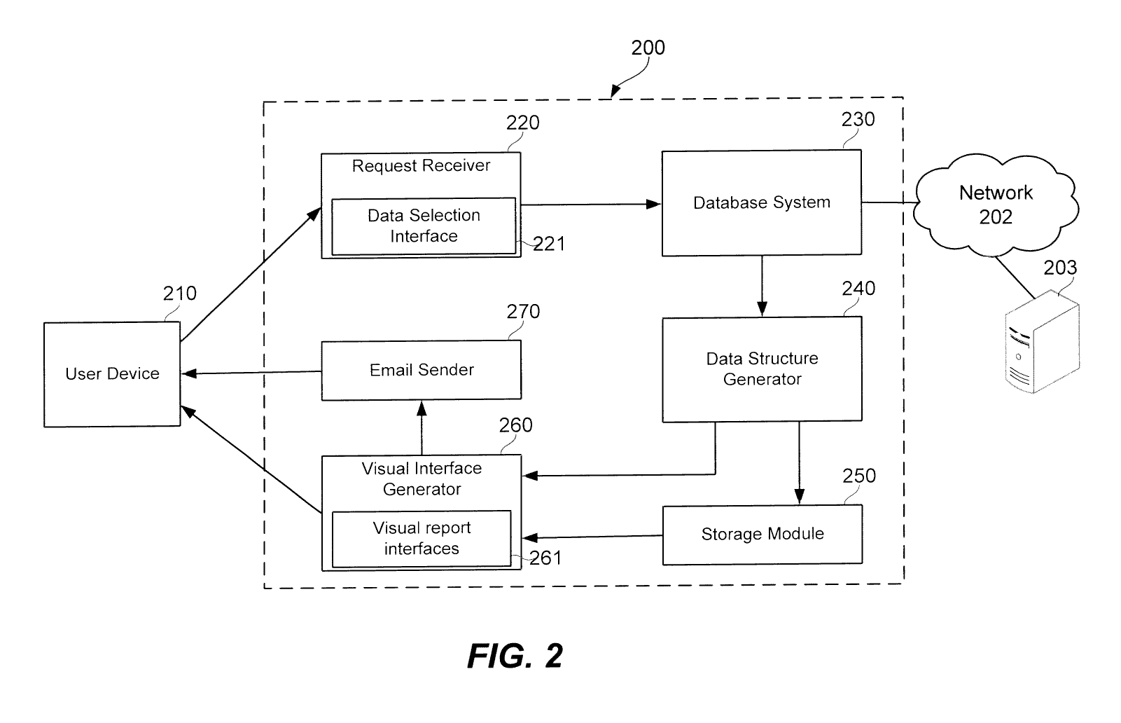

FIG. 2 shows an exemplary system 200 for data visualization according to an embodiment of the disclosure. The system 200 can include a request receiver 220, a database system 230, a data structure generator 240, a storage module 250, a visual interface generator 260 and an email sender 270. Those components are coupled together as shown in FIG. 2. In addition, as shown in FIG. 2, a user device 210 can communicate with the system 200 and request a data visualization service from the system 200.

Generally, data visualization is the presentation of data in a pictorial or graphical format, such as charts and maps. Data visualization enables users to see analytical results of data and makes complex data more understandable and usable.

In an embodiment, the data to be visualized is microblog data generated from a microblogging service, such as Twitter microblogging service, Facebook, and the like. The microblog data can include numerous microblog entries. In addition to a content generated by a user of the microblogging service, in an embodiment, each microblog entry of the microblog data can include a plurality of attributes, such as a spatial attribute, a temporal attribute, and multiple categorical attributes. The spatial attribute can include a location where the user posts the microblog, while the temporal attribute can include a time when the user posts the microblog. The categorical attributes can include, for example, a language attribute and a source attribute. The language attribute can determine in which natural language the microblog is written, while the source attribute can determine from which type of operating system (OS), device or application the microblog is posted. The categorical attributes are important sources for microblog data analysis and can be exploited to draw fruitful conclusions from the microblog data. For example, the language attribute, or the source attribute, along with geolocation information enables various analysis, such as microblog user language usage, spread of different devices in an area, analysis of standards of living in different regions, and the like.

Each of the categorical attributes can take one of multiple discrete values and each discrete value can indicate a particular category of the categorical attribute, referred to as an attribute category. For example, for a microblog posted in English, the language attribute can take a value indicative of English language, and the attribute category of the language attribute for this microblog is English language. For a microblog posted in Arabic, the language attribute can take a value indicative of Arabic language, and the attribute category of the language attribute for this microblog is Arabic language. Similarly, the source attribute can have different attribute categories for different operating systems, such as an Android attribute category for Android OS, an iOS attribute category for iOS operating system, and the like.

According to an aspect of the disclosure, a user can use the system 200 to visualize and analyze categorical attributes of microblog data. For example, through a data selection interface provided by the system 200, the user can send a request for visual report to the system 200 and the request can include arbitrary spatial and temporal ranges of selected microblog data and a particular categorical attribute to be analyzed. Based on the request, the system 200 can extract selected microblog data from the database system 230. Then, the system 200 can create a data structure that provides a specific scheme for storing data to be visualized.

Next, counts of attribute categories are computed for different regions and stored in the data structure. Specifically, a count of an attribute category can be based on distinct microblogs or distinct users. A count of an attribute category based on distinct microblogs is the count of microblogs belonging to each attribute category of the selected data set, while a count of an attribute category based on distinct users is the count of users who post microblogs belonging to each attribute category of the selected data set. Subsequently, the system 200 can generate a visual report and transmit the visual report to the user. The visual report can include multiple visual report interfaces. In each visual report interface, counts of attribute categories retrieved from the data structure can be visually presented, for example, using various charts overlaid with a map, such as a Google map.

The user device 210 can be a computer, such as a desktop computer, a laptop computer, a tablet computer, a mobile phone, and the like. The user device 210 can communicate remotely with the system 200 via a communication network (not shown). The communication network can be a local area network (LAN), such as a Ethernet network, a Wi-Fi network, and the like, or a wide area network (WAN), such as the Internet, a third generation (3G) wireless mobile network, a fourth generation (4G) wireless network, and the like. In alternative embodiment, the device 210 and part or all of the components of the system 200 can be integrated into one system, and the functions previously performed by the device 210 can be implemented as a module in the system 200. Thus, the module can communicate with other components of the system 200 locally.

In the FIG. 2 example, the user device 210 can receive a data selection interface from the request receiver 220 and display the interface on the user device 210. Through the interface, a user of the user device 210 can select the spatial and temporal ranges of the microblog data and determine the categorical attribute to be analyzed, and subsequently a request for visual report can be sent to the request receiver. The request for visual report can include the data selection requirement of the user. In an embodiment, the user device 210 can include a web browser and communicate with the request receiver 220 using the hypertext transfer protocol (HTTP). The data selection interface can be a webpage written in hypertext markup language or other comparable markup language. The webpage can be received and displayed in the web browser.

The request receiver 220 can include a data selection interface 221. As a response to an initial request from the user device 210, the request receiver 220 can send the data selection interface to the user device 210. Subsequently, the request receiver 220 can receive the request for visual report from the user device and transmit the selected data ranges and the categorical attribute to be analyzed to the database system 230.

The database system 230 can include a storage and a query engine. The storage can be configured to store the microblog data, and the query engine can be used to extract microblog data according to the spatial and temporal ranges selected by the user. For example, in an embodiment, the microblog data is Twitter data, and the user chooses to analyze language attribute of Twitter data in the region of Gulf Arab states during the period from December 2013 to February 2014. Thus, Twitter data in the region of Gulf Arab states during the period from December 2013 to February 2014 is extracted from the database. The extracted data can then be transmitted to the data structure generator 240 for further processing.

The database system 230 can communicate with a remote computer 203 via a network 202 to obtain the microblog data. In an embodiment, the database system 230 can use an application program interface provided by a microblog service provider to obtain microblog data from the microblog service provider's database. For an example, the database system 230 can use Twitter Streaming Application Program Interfaces (APIs) provided by Twitter, Inc. company to receive a Twitter microblog data stream from a remote server. Specifically, the database system 230 can use a local client application to send a request to the remote server to set up a HTTP connection. The remote server can then retrieve microblog data from a database inside a network of Twitter company and transmit the Twitter microblog data to the database system 230. In an example, the Twitter microblog data is transmitted in real time while the Twitter users are posting microblogs using Twitter service. In an alternative embodiment, the database system 230 can access a microblog service provider's database using account information of one or more users who register for the microblog service provider's service to obtain the microblog data posted by the users.

The network 203 can be a wide area network (WAN), such as the Internet, a third generation (3G) wireless mobile network, a fourth generation (4G) wireless network, and the like.

Based on the extracted data received from the database system 230, the data structure generator 240 can create the data structure to store counts of different attribute categories of the selected categorical attribute. In an embodiment, an adaptive pyramid data structure is created to store counts of different attribute categories at different levels of granularity. Particularly, the pyramid data structure can be created through the following two phases: a structuring phase and a computation phase. During the structuring phase, the pyramid data structure is initialized as one root cell that covers the whole region corresponding to the selected spatial range and contains all the microblog entries in the extracted data. The root cell is then divided into multiple disjoint children cells, each covering a sub-region that is a portion of the whole region. The microblogs in the root cell are replicated in its children cells according to their spatial locations indicated by the spatial attribute of each microblog entry of the microblog. Any children cell that has a number of microblogs larger than a predetermined capacity threshold is further divided into multiple children cells. The process is repeated recursively for each cell until the count of microblogs in each leaf cell is less than or equal to the capacity threshold. At the end of the structuring phase, the pyramid data structure containing microblog entries is created.

During the computation phase, the counts of each attribute category for the microblog data in each pyramid cell, either a leaf cell or a non-leaf cell, are computed and stored in the cell. When computing the counts based on distinct microblogs, as described above, every individual microblog in the cell is considered even if multiple microblogs are posted by a same user. On the contrary, when computing the counts based on distinct users, all microblogs from the same user only are considered once. In addition, microblog entries are removed from the pyramid data structure after the computation.

Each cell stores the counts of attribute categories, either based on distinct users or distinct microblogs, in hash tables with the attribute categories as keys and the corresponding counts as values. The hash tables can be based on distinct microblogs or based on distinct users. For example, if a certain cell has 80 microblogs from the iOS operating system posted by 40 users, 60 microblogs from the Android operating system posted by 30 users, and 40 microblogs from the Windows Mobile operating system posted by 20 users, then the distinct microblog based hash table can contain three pairs of <iOS, 80>, <Android, 60>, and <Windows, 40>, while the distinct user based hash table can contain three pairs of <iOS, 40>, <Android, 30>, and <Windows, 20>. At the end of the computation phase, the pyramid data structure containing the counts based on distinct users or microblogs can be obtained, and stored into the storage module 250.

The storage module 250 can include nonvolatile storage and volatile storage. The nonvolatile storage can be hard disks, flash memory, optical discs, and the like, while volatile storage can be random access memory (RAM) and the like. The storage module 250 can store the data structured created at the data structure generator 240, for example, in a disk, thus that the data structure can be used for visualization operation at the visual interface generator 260.

The visual interface generator 260 can generate a visual report to visualize the content of the data structure stored in the storage module 250. The visual report can comprise multiple visual report interfaces 261. In an example, the report interfaces visualize the content of the pyramid structure on a map-based interface at different zoom levels where each map level corresponds to a level in the pyramid data structure. In addition, the report interfaces are interactive interfaces and a user can change the zoom level to be displayed. Further, the user can change the basis of the counts of the attribute categories between distinct-user-based and distinct-microblog-based.

In an example, the visual report interfaces are generated as web pages based on HTML and the visual interface generator 260 can communicate with the user device using HTTP.

In an embodiment, triggered by the data structure generator 240 after the data structure is created, the visual interface generator 260 can load the data structure from the disk in the storage module 250 to a memory (not shown), such as a random access memory (RAM). Subsequently, the visual interface 260 can read the counts of the attribute categories from different cells in a level of the pyramid data structure and display the counts, for example, in different pie charts overlaid with different regions of a map. Specifically, each zoom level of the map corresponds to a level of the pyramid data structure, and each region in the map corresponds to a cell in the level of the pyramid data structure. In an example, an initial visual report interface can display the counts of attribute categories with a default map zoom level, and subsequently the succeeding visual report interfaces can display according to user's choice of map zoom levels.

In an embodiment, after an initial visual report interface is generated, the visual interface generator 260 can cause the email sender 270 to send an email to the user. The email can include a hyperlink directed to the initial visual report interface. The user can access the visual report by selecting the hyperlink in the email. In another embodiment, the visual interface generator can directly send the initial visual report interface to the user device 210 as a response to the user's request for visual report without sending the email. Subsequently, the visual generator 260 can send succeeding visual report interfaces to the user device 210 according to the user's choice of map zoom levels or other options.

The email sender 270 can be configured to send emails to an email address provided by the user when submitting the request for visualization from the user device 210 to the request receiver 220 as described earlier.

It should be appreciated that one or more components in the system 200 could be combined into a single component providing aggregate functionality. For example, the request receiver 220 and the visual interface generator 260 can be combined as a single front end component interacting with the user device 210 to receive the user request for visual report and supply visual report interfaces to the user.

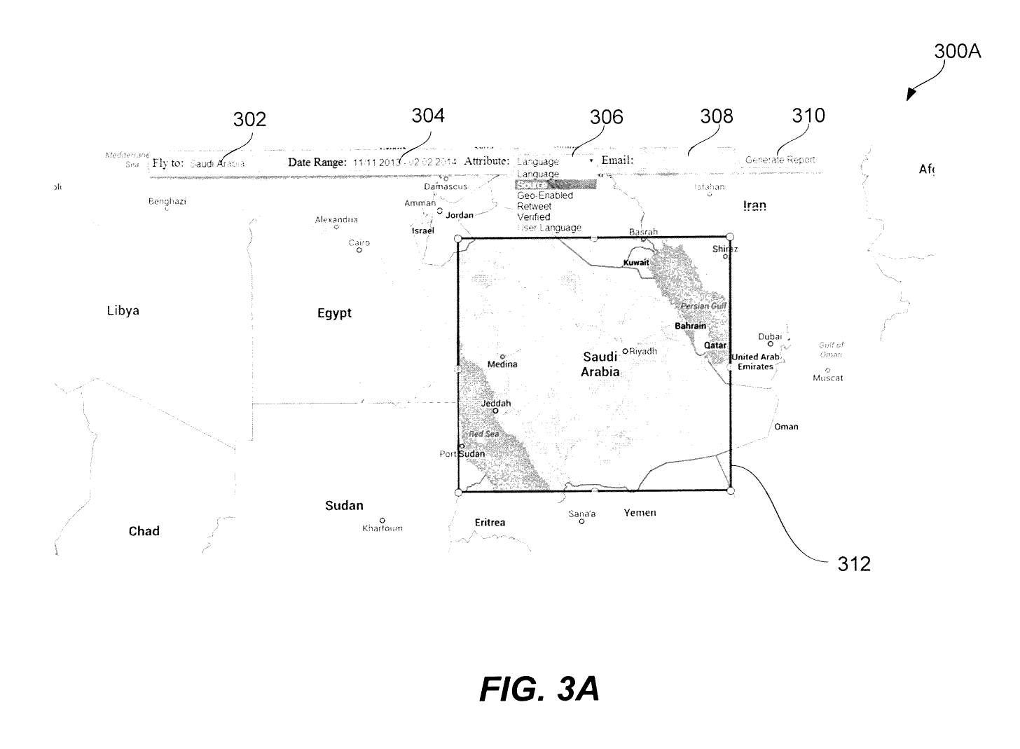

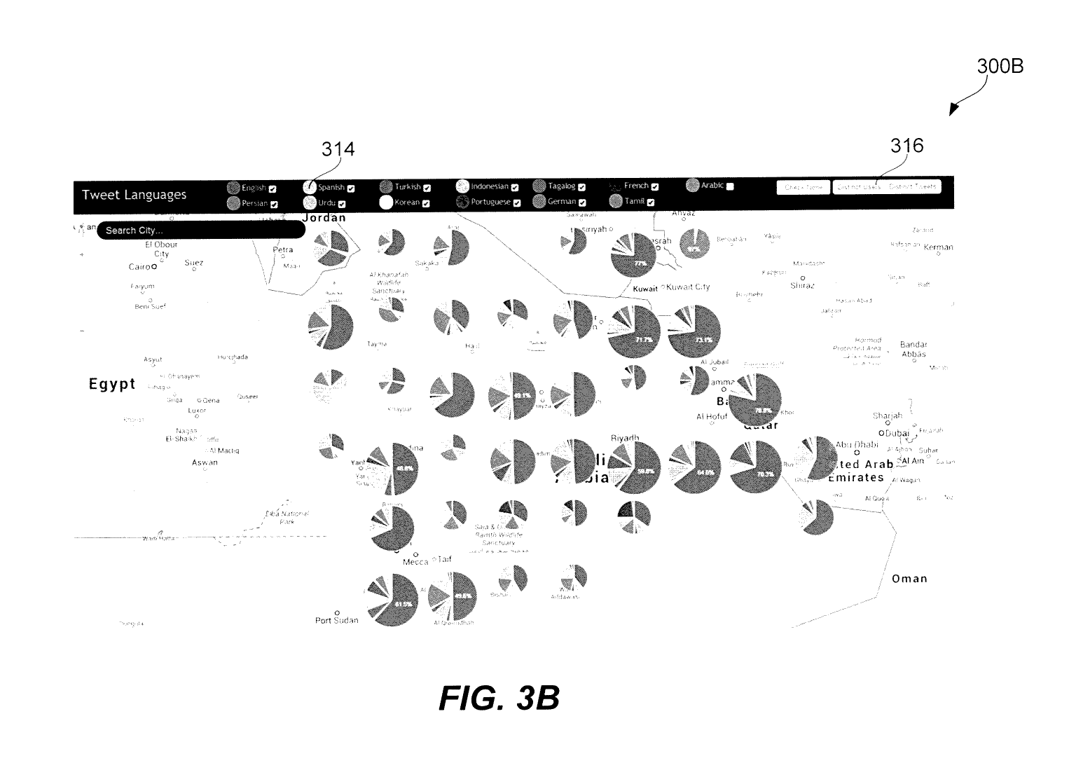

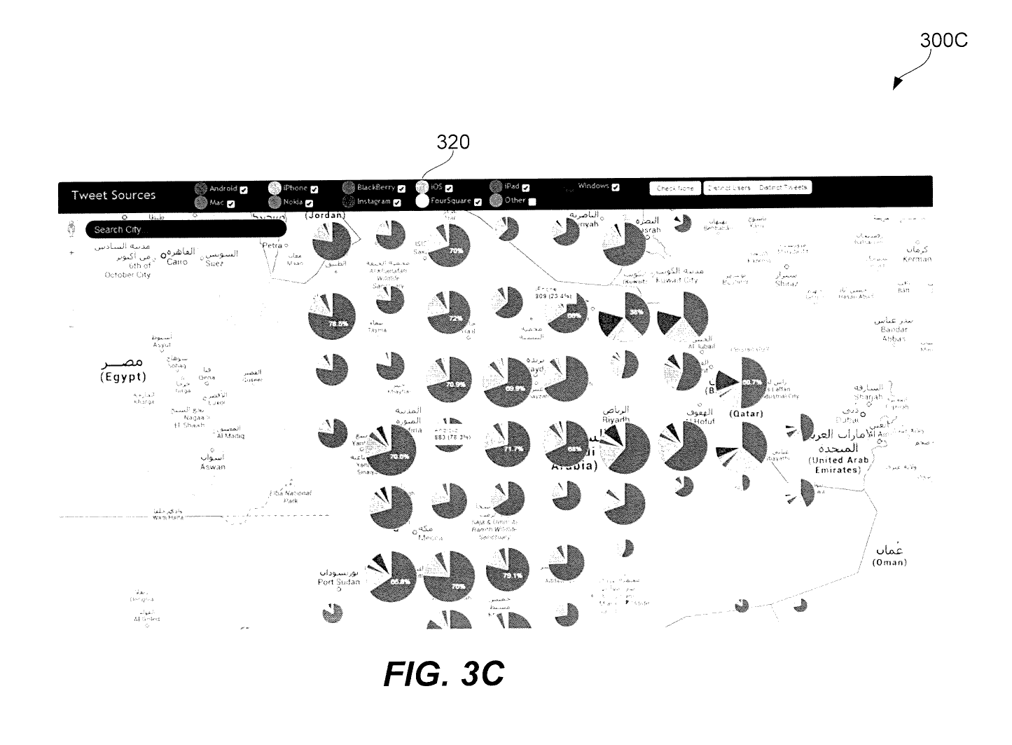

FIGS. 3A-3C show exemplary interfaces generated by the system 200 according to an embodiment of the disclosure.

FIG. 3A shows an exemplary data selection interface 300A. The interface 300A can be generated by the request receiver 220 and displayed at the user device 210. The interface 300A can include a plurality of functions or input fields through which a user can choose spatial and temporal ranges of the microblog data and the categorical attribute to be analyzed. In the FIG. 3A example, the interface 300A is a map based interface. The interface 300A can include a “Fly to” input field 302 where the user can choose a region of the map to be displayed by input of a name of the region. Based on the displayed map, the user can select the spatial range of the microblog data, for example, by choosing a certain area 312 in the map. Further, the interface 300A can include a “Date Range” input field where the user can input a date range to choose the temporal range of the microblog data, and a “Attribute” input field where the user can choose the categorical attribute of the microblog data to be analyzed. Still further, the interface 300A can include an “Email” input field where the user can input an email address to receive an email from the email sender 270 when the visual report interfaces are generated. In addition, the interface 300A can include a “Generate Report” button by clicking which the user can submit the request for visual report to the request receiver 220.

FIG. 3B shows an exemplary interactive visual report interface 300B for language categorical attribute analysis. As shown, the microblog data in this example is tweet data from the Twitter microblogging service, and the region of the map is the area of the gulf Arab states. The interface 300B can show the counts and percentages of each language in each sub-region using charts, such as pie charts 318, and the charts are overlaid with a map, such as a Google map. In an example, the interface 300B is created as a web page written with HTML, and Google Maps API Web Services and Google Chart libraries are used to produce the webpage. Specifically, each sub-region corresponds to a cell in the pyramid data structure described earlier, and the counts of each attribute category in the cell are displayed in a pie chart corresponding to the sub-region. The size of the pie charts 318 indicates the relative size of tweets in its corresponding region.

In addition, different languages can be represented with different colors in the pie charts. The interface 300B can include an attribute category selection function 320 where types of language are listed and can be included or excluded selectively such that the user can compare the aggregates of any combination of the languages.

Further, the zoom level of the map in the interface 300B can be adjusted such that finer granularity aggregate counts of attribute categories can be shown in smaller regions. Specifically, when the user changes the zoom level, a parameter indicative of the zoom level can transmitted to the visual interface generator 260. According to the zoom level, the level in the pyramid data structure can be determined at the visual interface generator 260. Accordingly, for each cell in that determined level, the name of the sub-region and the counts of each attribute category can be obtained. These names and counts are fed to a webpage, which is, for example, written in HTML and uses Google Maps API Web Services and Google Chart libraries, to generate an interface with the changed zoom level. The interface is transmitted to the user device 210 and presented to the user.

Additionally, the interface 300B can include a function 316 through which the user can choose to display the aggregate counts of attribute categories based on distinct users or distinct microblogs. In the FIG. 3B example, the interface 300B can be based on distinct microblogs initially. Subsequently, the user can use the function 316 by, for example, click a button to display the aggregate counts based on distinct users.

FIG. 3C shows an exemplary visual report interface 300C for source categorical attribute analysis. The function and appearance of the interface 300C is similar to the interface 300B except that source categorical attribute is chosen to be analyzed. Accordingly, options of operating systems 320 are presented in the interface, and the aggregate counts and percentages of different operating systems in each sub-region are displayed using the pie charts.

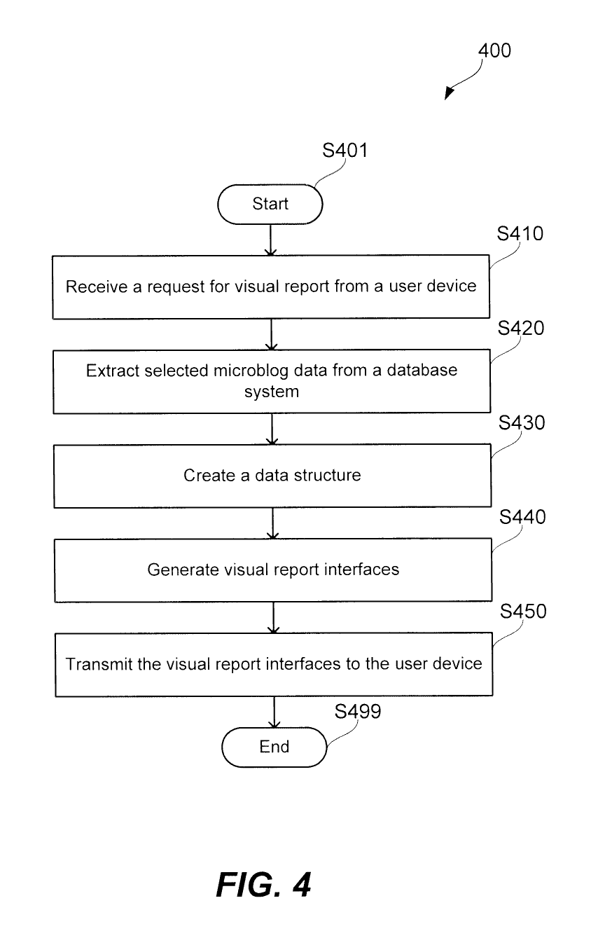

FIG. 4 shows a flow chart of a process 400 for data visualization according to an embodiment of the disclosure. The process 400 can be performed in the FIG. 1 example. The process starts at S401 and proceeds to S410.

At S410, a request for visual report can be received from a user device at a request receiver. The request for visual report can be generated based on a data selection interface where the user can choose the spatio-temporal ranges of the microblog data and a categorical attribute to be analyzed. The data selection interface can be generated at the request receiver and transmitted to the user device as a response to an initial request from the user device. After receiving the request for visual report, the rest receiver can send the data selection requirement to a database system.

At S420, based on the data selection requirement, selected microblog data can be extracted from the database system. Data stored in the database system can be microblog data, such as Twitter tweets, Facebook comments, and the like. The selected micro data is supplied to a data structure generator.

At S430, a data structure can be created at the data structure generator. In an embodiment, the data structure is a pyramid data structure. The pyramid data structure can be created through a structuring phase and a computation phase. During the structuring phase, in a recursive manner, a parent cell corresponding to a region is divided into multiple children cells corresponding to a portion of the region until counts of microblogs in each cell are below a capacity threshold. During the computation phase, aggregate counts of each attribute category in each cell are computed based on distinct users or distinct microblogs. The counts can be stored in two hash tables, one for distinct microblogs and the other for distinct users, with attribute categories as keys and counts of microblogs or users of each attribute category as values.

In an example, the created data structure is stored in a hard disk to be used by a visual interface generator.

At S440, visual report interfaces are generated for visualizing the microblog data. In an example of the visual report interface, the counts of attribute categories of selected microblog data in different regions are displayed using pie charts overlaid with a map. The visual interface generator can interactively generate interfaces according to requests received from the user device. For example, based on user requests, the interfaces can display the map at different zoom levels, display different combination of attribute categories, and display the aggregate counts based on distinct users or distinct microblogs.

At S450, visual interfaces are transmitted to the user device. In an example, an email including a link to the visual report is sent to the user after the visual report interface is generated. When the user clicks the link, the visual report interface is transmitted to the user device. In another example, the visual report interface can be directly transmitted to the user as a response to the original request for visual report from the user.

While for purposes of simplicity of explanation, the process 400 are shown and described as a series of steps, it is to be understood that, in various embodiment, the steps may occur in different orders and/or concurrently with other steps from what is described above. Moreover, not all illustrated steps may be required to implement the process described above.

The system and the process described above can be implemented with any suitable software or hardware. In an embodiment, the system and the process can be implemented as an application program comprised of computer-executable instructions that can be stored in a computer-readable media and can run on one or more computers. In alternative embodiments, the system and the process can be implemented in combination with other programs, such as operating systems and program modules of other applications, or can be implemented as a combination of hardware and software.

In addition, the system and the process described above can be implemented with various suitable computer system configurations, such as single-processor or multiprocessor computer systems, minicomputers, mainframe computers, as well as personal computers, hand-held computing devices, microprocessor-based or programmable consumer electronics, and the like.

Further, the system and process described above can also be implemented in distributed computing environments. In a distributed computing environment, program modules can be located in both local and remote memory storage devices, and certain functions can be performed by remote processing devices that are linked to local processing devices through a communications network.

Still further, information such as computer-readable instructions, data structures, program modules or other data can be stored in a variety of computer storage media, such as random access memory (RAM), read-only memory (ROM), electrically erasable programmable read-only memory (EEPROM), flash memory, compact disc read-only memory (CD-ROM), digital versatile disk (DVD) or other optical disk storage, magnetic cassettes, magnetic tape, magnetic disk storage, and the like.

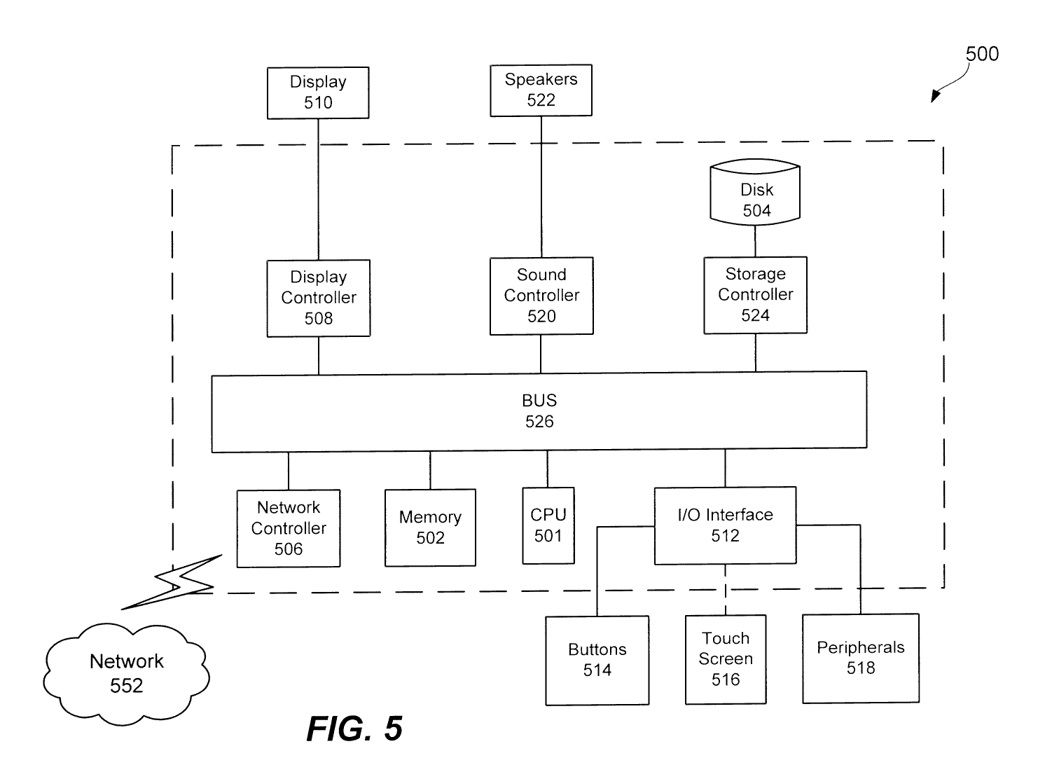

FIG. 5 shows an exemplary computing environment 500 for implementing various aspects of the disclosure including the system 200 and the user device 210. In FIG. 5, the computer 500 includes a CPU 500 which performs the functions and processes described above. The data and instructions may be stored in a memory 502. These data and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 500 communicates, such as a server or computer.

Further, the claimed advancements may be provided as a utility application, background daemon, or component of an operating system, or combination thereof, executing in conjunction with CPU 501 and an operating system such as Microsoft Windows 7, UNIX, Solaris, LINUX, Apple MAC-OS and other systems known to those skilled in the art.

The hardware elements of the computer 500 may be realized by various circuitry elements, known to those skilled in the art. For example, CPU 501 may be a Xenon or Core processor from Intel of America or an Opteron processor from AMD of America, or may be other processor types that would be recognized by one of ordinary skill in the art. Alternatively, the CPU 501 may be implemented on an FPGA, ASIC, PLD or using discrete logic circuits, as one of ordinary skill in the art would recognize. Further, CPU 501 may be implemented as multiple processors cooperatively working in parallel to perform the instructions of the inventive processes described above.

The computer 500 in FIG. 5 also includes a network controller 506, such as an Intel Ethernet PRO network interface card from Intel Corporation of America, for interfacing with network 552. As can be appreciated, the network 552 can be a public network, such as the Internet, or a private network such as an LAN or WAN network, or any combination thereof and can also include PSTN or ISDN sub-networks. The network 552 can also be wired, such as an Ethernet network, or can be wireless such as a cellular network including EDGE, 3G and 4G wireless cellular systems. The wireless network can also be WiFi, Bluetooth, or any other wireless form of communication that is known. The computer 500 can communicate to one or more remote computers, such as a server computer, a router, a personal computer, portable computer, microprocessor-based entertainment appliance, a peer device or other common network node.

The computer 500 further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard.

A sound controller 520 is also provided in the computer 500, such as Sound Blaster X-Fi Titanium from Creative, to interface with speakers/microphone 522 thereby providing sounds and/or music.

The general purpose storage controller 524 connects the storage medium disk 504 with communication bus 526, which may be an ISA, EISA, VESA, PCI, or similar, for interconnecting all of the components of the computer 500. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chip.

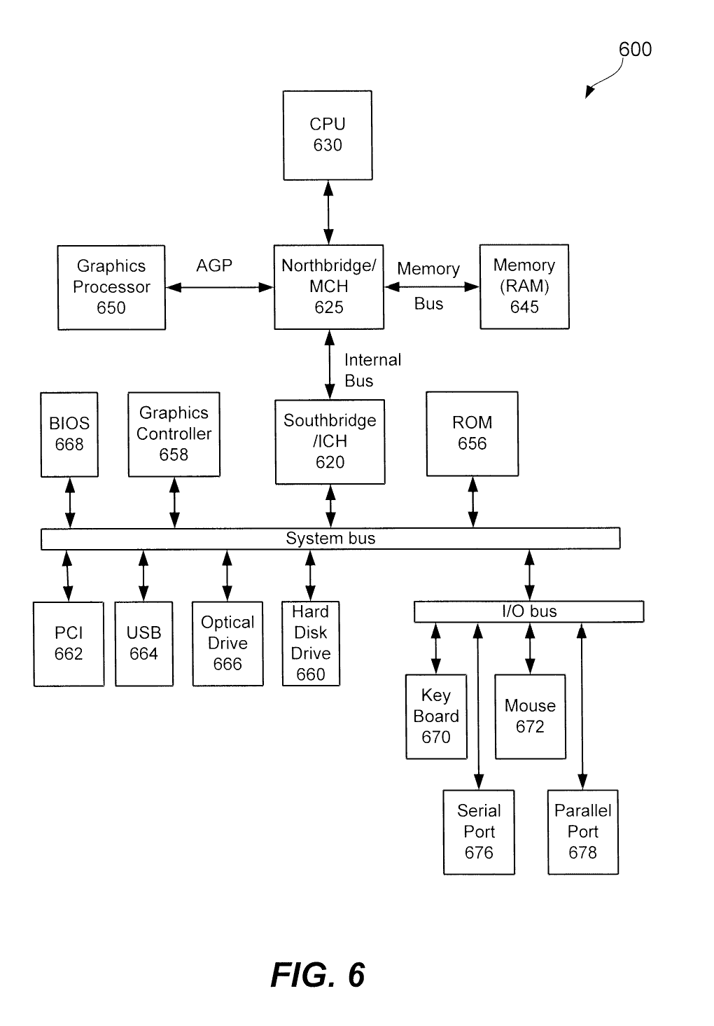

FIG. 6 shows an exemplary data processing system 600, according to certain embodiments, for implementing various aspects of the disclosure including the system 200 and the user device 210. The data processing system 600 is an example of a computer in which specific code or instructions implementing the processes of the illustrative embodiments may be located to create a particular machine for implementing the above-noted process.

In FIG. 6, data processing system 600 employs a hub architecture including a north bridge and memory controller hub (NB/MCH) 625 and a south bridge and input/output (I/O) controller hub (SB/ICH) 620. The central processing unit (CPU) 630 is connected to NB/MCH 625. The NB/MCH 625 also connects to the memory 645 via a memory bus, and connects to the graphics processor 650 via an accelerated graphics port (AGP). The NB/MCH 625 also connects to the SB/ICH 620 via an internal bus (e.g., a unified media interface or a direct media interface). The CPU Processing unit 630 may contain one or more processors and even may be implemented using one or more heterogeneous processor systems.

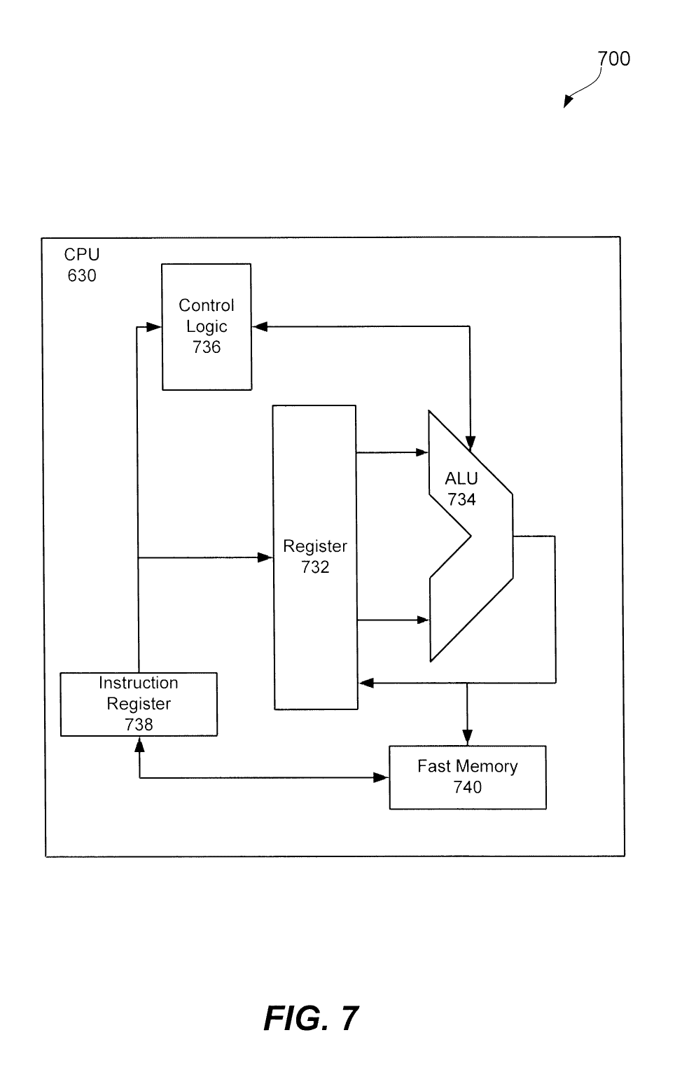

For example, FIG. 7 shows an exemplary implementation of CPU 630 according to an embodiment of the disclosure. In one implementation, the instruction register 738 retrieves instructions from the fast memory 740. At least part of these instructions are fetched from the instruction register 738 by the control logic 736 and interpreted according to the instruction set architecture of the CPU 630. Part of the instructions can also be directed to the register 732. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 734 that loads values from the register 732 and performs logical and mathematical operations on the loaded values according to the instructions. The results from these operations can be feedback into the register and/or stored in the fast memory 740. According to certain implementations, the instruction set architecture of the CPU 630 can use a reduced instruction set architecture, a complex instruction set architecture, a vector processor architecture, a very large instruction word architecture. Furthermore, the CPU 630 can be based on the Von Neuman model or the Harvard model. The CPU 630 can be a digital signal processor, an FPGA, an ASIC, a PLA, a PLD, or a CPLD. Further, the CPU 630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 6, the data processing system 600 can include that the SB/ICH 620 is coupled through a system bus to an I/O Bus, a read only memory (ROM) 656, universal serial bus (USB) port 664, a flash binary input/output system (BIOS) 668, and a graphics controller 658. PCI/PCIe devices can also be coupled to SB/ICH 620 through a PCI bus 662.

The PCI devices may include, for example, Ethernet adapters, add-in cards, and PC cards for notebook computers. The Hard disk drive 660 and CD-ROM 666 can use, for example, an integrated drive electronics (IDE) or serial advanced technology attachment (SATA) interface. In one implementation, the I/O bus can include a super I/O (SIO) device.

Further, the hard disk drive (HDD) 660 and optical drive 666 can also be coupled to the SB/ICH 620 through a system bus. In one implementation, a keyboard 670, a mouse 672, a parallel port 678, and a serial port 676 can be connected to the system bust through the I/O bus. Other peripherals and devices that can be connected to the SB/ICH 620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

The hardware description above, exemplified by any one of the structure examples shown in FIG. 5, 6, or 7, constitutes or includes specialized corresponding structure that is programmed or configured to perform the functions and processed described in FIGS. 1-4.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A system for visualizing microblog data, comprising:
circuitry that is configured to
receive a request for visual report from a user device;
extract the selected microblog data from a database based on the request for visual report;
create a pyramid data structure having a plurality of cells at different levels for data visualization based on microblog data within spatial and temporal ranges selected by a user; and
create a visual report including a plurality of visual report interfaces based on the data structure.

2. The system of claim 1, wherein the request for visual report from a user device includes spatial and temporal ranges of selected microblog data and a categorical attribute to be analyzed.

3. The system of claim 2, wherein the categorical attribute to be analyzed is a language attribute, and the visual report shows counts and percentages of each language in each sub-region of a region corresponding to the spatial range of the selected microblog data and is used for language attribute analysis.

4. The system of claim 2, wherein the categorical attribute to be analyzed is a source operating system attribute, and the visual report shows counts and percentages of each operating system in each sub-region of a region corresponding to the spatial range of the selected microblog data and is used for source attribute analysis.

5. The system of claim 1, wherein the circuitry is configured to compute counts of attribute categories of microblog data in each cell and store the counts of attribute categories in a hash table to create the pyramid data structure.

6. The system of claim 5, wherein the counts of attribute categories can be based on distinct users or distinct microblogs.

7. The system of claim 1, wherein the visual report interfaces are based on a map having a plurality of zoom levels, each zoom level corresponding to a level in the pyramid data structure, wherein counts of attribute categories in a cell in the pyramid data structure are displayed using a chart overlaid with a region in the map, the region corresponding to the cell in the pyramid data structure.

8. The system of claim 1, wherein the visual report interfaces include functions for a user to select the attribute categories to be displayed and choose to display the visual report interface based on distinct users or distinct microblogs.

9. The system of claim 1, wherein the circuitry is further configured to generate a data selection interface for a user to select spatial and temporal ranges of microblog data and categorical attribute to be analyzed for the visual report.

10. The system of claim 1,
the circuitry being configured to send an email to the user device, the email including a hyperlink to the visual interfaces generated at the visual interface generator.

11. A method for visualizing microblog data, implemented by a system having circuitry, comprising:
receiving, by the circuitry, a request for visual report from a user device;
extracting, by the circuitry, the selected microblog data from a database based on the request for visual report;
creating, by the circuitry, a pyramid data structure having a plurality of cells at different levels for data visualization based on microblog data within spatial and temporal ranges selected by a user; and
creating, by the circuitry, a visual report including a plurality of visual report interfaces based on the data structure.

12. The method of claim 11, wherein the request for visual report from a user device includes spatial and temporal ranges of selected microblog data and a categorical attribute to be analyzed.

13. The system of claim 12, wherein the categorical attribute to be analyzed is a language attribute, and the visual report shows counts and percentages of each language in each sub-region of a region corresponding to the spatial range of the selected microblog data and is used for language attribute analysis.

14. The system of claim 12, wherein the categorical attribute to be analyzed is a source operating system attribute, and the visual report shows counts and percentages of each operating system in each sub-region of a region corresponding to the spatial range of the selected microblog data and is used for source attribute analysis.

15. The method of claim 11, wherein creating a data structure for data visualization comprises:
computing counts of attribute categories of microblog data in each cell; and
storing the counts of attribute categories in a hash table.

16. The method of claim 15, wherein the counts of attribute categories can be based on distinct users or distinct microblogs.

17. The method of claim 11, wherein the visual report interfaces are based on a map having a plurality of zoom levels, each zoom level corresponding to a level in the pyramid data structure, wherein counts of attribute categories in a cell in the pyramid data structure are displayed using a chart overlaid with a region in the map, the region corresponding to the cell in the pyramid data structure.

18. The method of claim 11, wherein the visual report interfaces include functions for a user to select the attribute categories to be displayed and choose to display the visual report interface based on distinct users or distinct microblogs.

19. The method of claim 11, further comprising:
generating, by the circuitry, a data selection interface for a user to select spatial and temporal ranges of microblog data and categorical attribute to be analyzed for the visual report.

20. The method of claim 11, further comprising:
sending, by the circuitry, an email to the user device, the email including a hyperlink to the visual interfaces generated at the visual interface generator.
